(19) United States
(12) Patent Application Publication
(10) Pub. No.: US 2022/0410977 A1
(43) Pub. Date: Dec. 29, 2022

(54) Flexible Vehicle

(71) Applicant: Ho Keung TSE, Zhongshan City, Guangdong Province (CN)

(72) Inventor: Ho Keung TSE, Zhongshan City, Guangdong Province (CN)

(21) Appl. No.: 17/426,102

(22) PCT Filed: Dec. 11, 2020
(86) PCT No.: PCT/IB2020/061837

§ 371 Date: Jul. 28, 2021

(30) Foreign Application Priority Data
Mar. 1, 2020 (GB) 2002936.9
Mar. 9, 2020 (GB) 2003360.1
Mar. 12, 2020 (GB) 2003571.3
Mar. 21, 2020 (GB) 2004142.2
Apr. 16, 2020 (GB) 2005517.4
Apr. 23, 2020 (GB) 2005963.0
Apr. 29, 2020 (CN) 202010359207.3

(51) Int. Cl. B62D 24/04; B62D 39/00; B60R 21/0134

(52) U.S. Cl. CPC B62D 24/04; B62D 39/00; B60R 21/0134; B60R 2021/01013

(57) ABSTRACT

A vehicle with a pod separable from a chassis therein, and when a collision detection system detects a collision or an imminent collision, the system will issue a signal to cause an electro-mechanical locking system to detach the pod from the chassis, and further, to move the pod partly or completely out of the vehicle to escape the collision.

### CROSS-REFERENCE TO RELATED APPLICATIONS

This application is a national stage application, filed under 35 U.S.C. § 371, of International Patent Application No. PCT/IB2020/061837, filed on Dec. 11, 2020.

This application is related to another PCT International application PCT/IB2021/051670 filed on Mar. 1, 2021, and U.S. patent application Ser. No. 15/929,449 filed May 4, 2020, on the grounds that they contain common subject matter.

This application is also related to UK patent application GB 2007051.2 filed on May 13, 2020 and China patent application 202010359207.3, filed on Apr. 29, 2020, on the grounds that they contain common subject matter. Actually, the UK application shares the same English specification with the U.S. application Ser. No. 15/929,449, whereas the China application is a China translation of the English specification.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION BY REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

### 1. Field of the Invention

The present invention relates to a vehicle with a passenger pod, and particularly, to enabling movement of the pod in different manners, when in an accident, or for pod transferring.

### 2. Description of Related Art of the Invention

Conventionally, passengers in a vehicle are protected by airbags in a collision, however, serious injuries are still unavoidable.

And, in the recent years, vehicles with their individual chassis separable from a pod therein are proposed by different automobile manufacturers.

For example, PCT patent application WO2021008874A1 of Rinspeed Inc. discloses transfer or exchange of a cabin of a vehicle, with an adjacent platform. However, it does not touch on an issue of how to protect a chassis of the vehicle, when separated from the cabin, from being intruded by another vehicle.

U.S. Pat. No. 8,041,483 and China utility model patent CN205971195U disclose using airbags to protect a vehicle and a cabin separated from a chassis, respectively, and their manner of protection is depending on the severity of an anticipated impact. The latter patent, in particular, discloses ejecting the cabin out of the vehicle.

### BRIEF SUMMARY OF THE INVENTION

It is therefore an object of the present invention to provide a better protection, by separating and protecting a pod which is used for carrying humans, from a chassis of a vehicle, in an accident.

To achieve the object, the present invention, similar to the above-mentined prior art, can move a pod partly or completely out of a vehicle, to escape from an accident. And, in what way the pod should be moved, or not to be moved, according to the fourth embodiment of the present invention, as will be discussed herein below, depends not only on information of a collision impact detected, but also nearby objects detected, such as a pedestrian or a vehicle.

It is therefore another object of the present invention to protect a chassis of a vehicle from intrusion by another vehicle, when the vehicle is not carrying a pod.

To achieve the object, the present invention provides an impact resisting/absorbing device, for preventing entry of another vehicle into a space left by the detached pod, in the chassis.

### BRIEF DESCRIPTION OF THE DRAWINGS

FIG. 1 is a schematic diagram of an exemplified vehicle with a pod separable from a chassis therein.

FIG. 2 is a schematic diagram of an exemplified vehicle in an accident, with a pod separated from a chassis therein, and cushions disposed beneath the pod are inflated.

FIG. 3 is a schematic diagram of a chassis of an exemplified vehicle, with a support plane 17 for raising up a pod thereon.

FIG. 4 is a schematic diagram of an exemplified vehicle with a pod separable and movable from a chassis therein, viewed from above.

FIG. 5 is a schematic diagram of an exemplified vehicle with a planar surface chassis, and its support plane 24 for pod transferring.

FIG. 6 is a schematic top view of support plane 24.

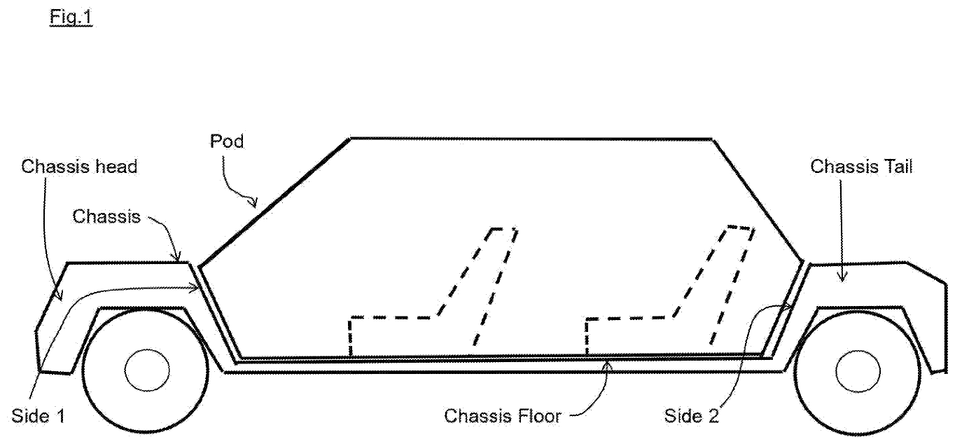

Note that the above figures may not be in proportional, and for instance, in FIG. 1, the gaps between the pod and the chassis are greatly exaggerated to avoid confusion, and in real practice, such gaps may exist but should be negligible.

### DETAILED DESCRIPTION OF THE INVENTION

According to a first embodiment of the present invention and referring to FIG. 1, in an exemplified vehicle, a pod is detachably secured to a chassis by an attachment and detachment device which may be a multi-point electro-mechanical locking system, and when a control system detects or anticipates a collision, it issues a signal, to firstly cause the attachment and detachment device to detach the pod from the chassis, then a control signal, as will be discussed herein below in details.

The control system, with or without autonomous driving capability, can use any of a variety of technologies including but not limited to a shock/impact sensor, camera, a LiDAR system, infra-red sensor system, radar system (including but not limited to millimeter wave radar, noise radar, micro-power impulse radar, and ultra wideband radar), acoustical system, artificial intelligence system or a combination of these, and may include a crash anticipatory unit such as the one as disclosed in U.S. Pat. No. 8,041,483.

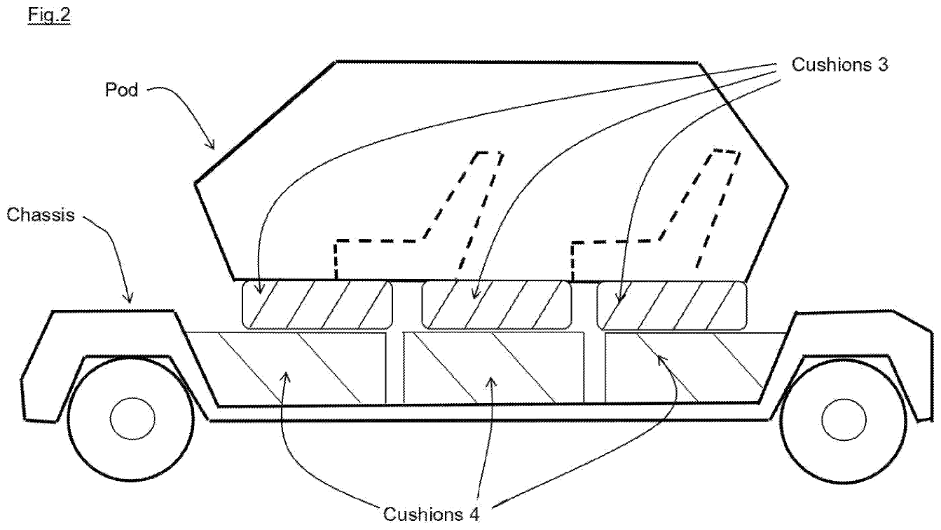

And, referring to FIG. 2, cushions 3 and 4 are disposed on the pod and the chassis respectively, and therefore, cushions 3 will move with the pod and continue to protect the pod, in a collision. Both cushions 3 and 4, when inflated, will respectively occupy a space below the pod and above the chassis floor, and therefore, cushions 3 and 4 can be used to raise the pod up, separately or collectively, if the pod is detached from the chassis and not being moved away from the chassis.

Note that any conventional shock-absorbing, energy dissipating, inflatable or expansible devices may be used as cushions 3 and/or 4, such as conventional vehicle airbags used for reducing impact in accidents.

The cushions 4 are dedicated for enabling movements of the pod towards a comparatively high barrier, for instance, the upward protruding (that is, not flush with the chassis floor) head and tail of the chassis, as shown in FIG. 1.

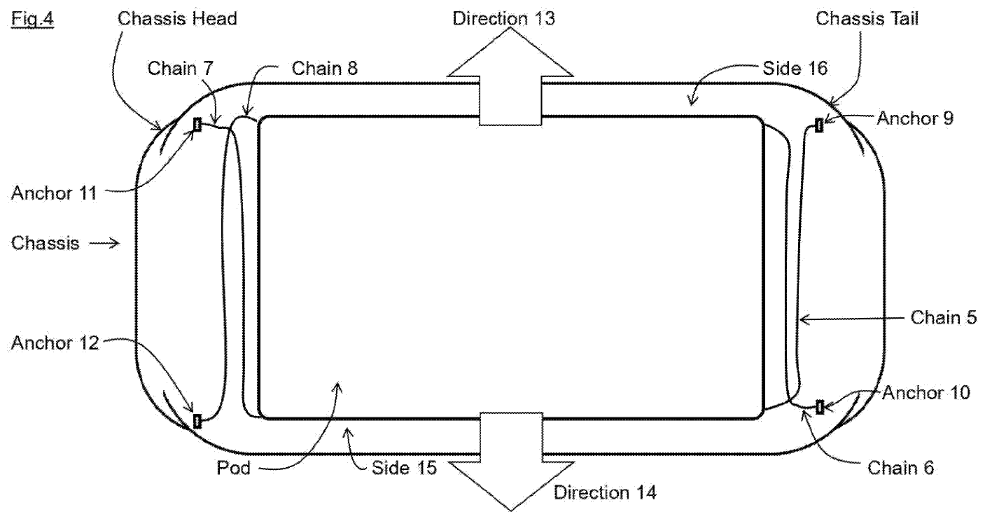

And therefore, inflation of the cushions 4 would be unnecessary when a side impact occurs/is to occur, because this simply means the pod will be unnecessarily dropped from a higher level to ground. The reason is that the pod can be moved out of the chassis by the side impact, in directions 13 or 14, without being raised up by cushions 4, as the chassis have no side wall (see FIG. 4, sides 15, 16 of the pod), or no barrier there to prevent the lateral movement.

As such, cushions 3 are used for assisting the pod to hurdle minor obstacle or reducing any possible frictions between the pod and the chassis floor, as well as for, absorbing shock when the pod hits ground.

Accordingly, the control system issues a first control signal for inflating both cushions 3 and 4, if the impact detected/anticipated would force the pod to move from a low-level part towards a high-level part of the chassis, and issues a second control signal for inflating cushions 3 only, if the impact detected/anticipated would force the pod to move from a part towards another part of substantially the same level, or move out of the chassis directly.

Referring to FIG. 2, when cushions 3 and 4 are inflated, they should desirably but not necessarily altogether raise the pod up to a level above the chassis, to avoid the pod from crashing against the upward protruding chassis head or tail, if it is caused to be moved forward or backward (that is, longitudinal direction), by the detected/anticipated impact which may be frontal or rear impacts, directly or indirectly, and this depends very much on the inclination of the side 1 or side 2 of the chassis, both enclose the front and rear of the pod respectively, and a smaller inclination can better facilitate the pod's upward movement and thereby, preventing the crash, refers to FIGS. 1 and 2.

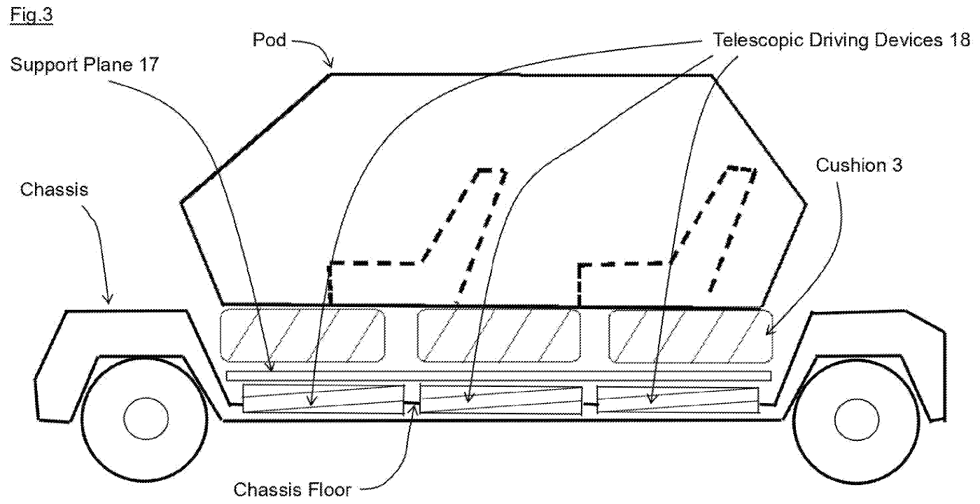

According to a second embodiment which is a modification the first embodiment, and referring to FIG. 3, a vertically movable support plane 17 is provided, to replace the role of cushions 4 in the first embodiment, and it lays on the chassis floor, when no accident occurs, to allow the pod resting on it, in a normal use position, be detachably secured to the chassis directly or indirectly. The first control signal causes mechanical or hydraulic or pressurized fluid device(s) (not shown in FIG. 3), or the like, to extend the telescopic driving devices 18, thereby moving the support plane 17 upward, for facilitating movement of the pod towards the upward protruding part of the chassis. Note that both support plane 17 or cushions 4 may be used to raise the pod to a level above the chassis.

Note that the pod may be detachably secured to support plane 17 instead, and may also be detached from the support plane 17, after having been moved up by support plane 17.

In the first and second embodiments, cushions 4 and/or support plane 17 and/or telescopic driving devices 18 may itself/themselves, with or without additional reinforcing material and/or structure, be capable of acting as an impact resisting and/or absorbing device to minimize/prevent intrusion by an external object into the vehicle.

And in a modification of the second embodiment, if a side impact on the vehicle is detected/anticipated by the control system, it issues a third control signal, to cause telescopic driving devices 18, at the side facing the side impact, to be extended to a first extent, so as to raise up the side of the support plane 17 facing the side impact, to a level that the support plane 17 will better prevent intrusion.

The telescopic driving devices 18 at the other side not facing the side impact may or may not be caused by the third control signal to be extended to the same extent as the first extent, and if not extended at all or extended by a comparatively small extent, the support plane 17 will be tilted in such a way that it will facilitate or directly cause the pod to slip in a direction far from the side impact.

If support plane 17 is to be tilted, the third control signal will contain information indicative of which side (side 15 or side 16, refer to FIG. 4) of the support plane 17 is/will be impacted or should be raised up, and for causing the telescopic driving devices 18 at both sides be extended accordingly.

Note that the control system may use a tilt sensor, for e.g., a pendulum or MEMS (Micro-Electro-Mechanical Systems) type, to detect the degree of tilting of the vehicle, which may be caused by the accident, or by the unevenness and tilting of the lane on which the vehicle is using, and basing on the tilting detected, the control system includes an adjustment information into the third control signal, so as to cause telescopic driving devices 18 to introduce a corresponding compensational adjustment on the tilting of support plane 17.

This tilting compensational adjustment technique is also advantageously applied to the platforms for pod transfer, as will be discussed herein below, to ensure the platforms involved are horizontal, and with no tilting.

Alternatively, a pressure sensor may be disposed on support plane 17 to sense the weight of the pod, so as to detect if the pod is moved completely out of support plane 17, and if it is, the pressure sensor issues a signal to the control system which in response, causes telescopic driving devices 18 at both sides of support plane 17 to be extended equally, so that support plane 17 is raised up to a predetermined level with no tilting, in order that support plane 17 and telescopic driving devices 18 can both occupy or at least better occupy the empty space created when the pod is moved away from the chassis and thus, preventing intrusion of an external object, says, a vehicle, into the chassis from BOTH SIDES, which may be a first or a subsequent collision.

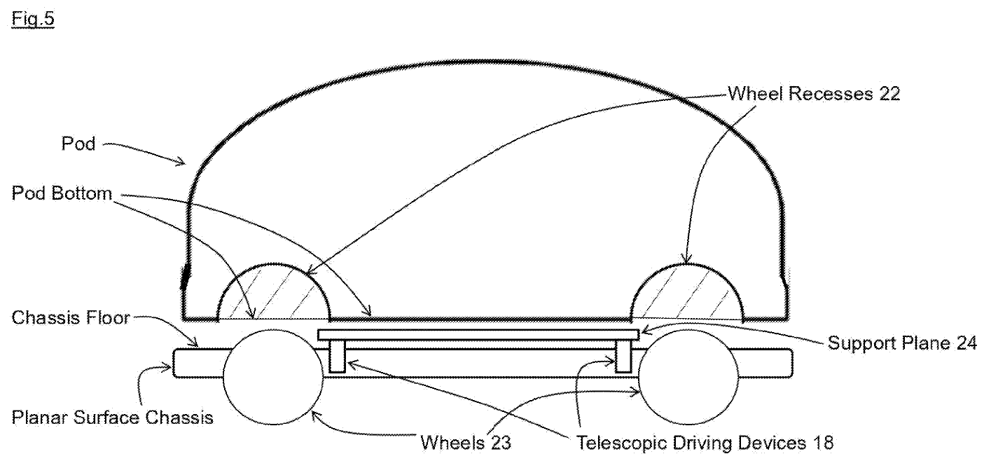

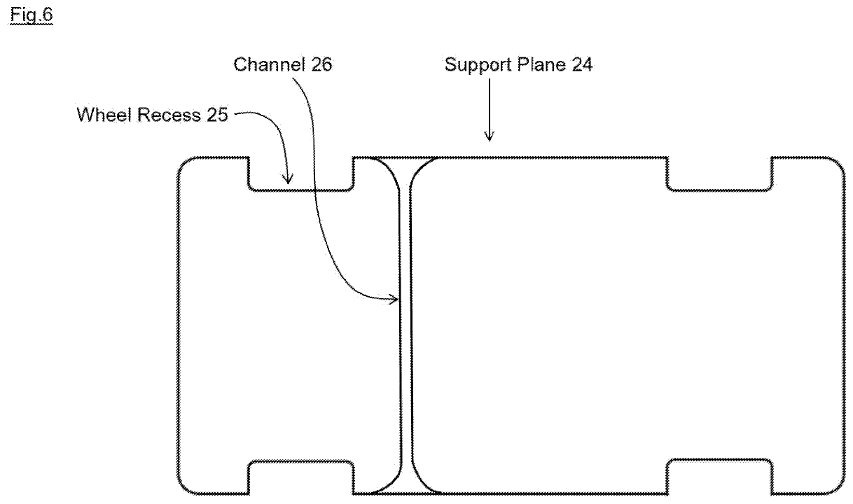

Note that if the chassis is planar surface, as shown in FIG. 5, then raising up support plane 24, as shown in FIG. 6, in the same manner as support plane 17, will preventing intrusion of an external object into the chassis from all four sides.

Any traditional techniques for elevating and tilting a platform, can be applied in support plane 17 and telescopic driving devices 18, and U.S. Pat. Nos. 6,085,670, 5,400,720 and US patent application 20080001130 are incorporated herein by reference, they provide illustrative, non-limiting examples. The 670' patent discloses a multi-directional tiltable platform system which is built by stacking a number of uni-directional tiltable platforms, whereas the 720' patent discloses a scissor lift mechanism for uplifting a tiltable table. And, the US patent application discloses a platform lifted by inflatable airbag(s).

According to a third embodiment and referring to FIG. 4, for simplicity and by way of example, the exemplified vehicle has no cushions 3, 4, support plane 17, or telescopic driving devices 18, but any of them may be included advantageously. The pod is connected with the chassis with chains 5, 6, 7, 8 (alternatively, steel cable or the like), and they are for moving the pod, when the pod is detached from the chassis in the above-mentioned manner. Note that FIG. 1 is also applicable to the exemplified vehicle of the third embodiment, as a side view thereof.

Each of the chains has one end respectively attached to a different corner, says, corner A of the pod, and the other end of each chain is respectively attached to a different anchor installed on the chassis, and the anchor is close to a corner of the pod, adjacent to corner A. And consequently, each chain will cause the pod to move in a direction towards the anchor it attached, if retracted.

When the control system detects/anticipates a side impact, on side 15 or 16, it issues respectively corresponding signals to cause a first electro-mechanical device to retract both chains 5 and 7, or both chains 6 and 8 correspondingly, as well as to cause a second electro-mechanical device to release/cut off both chains 6 and 8, or both chains 5 and 7 correspondingly, thereby, causing the pod to move in direction 13 or 14 correspondingly.

Further, when the pod is moved completely or substantially out of the chassis, the first electro-mechanical device may completely release or cut off the retracted chains, so that the chains will not hinder the movement of the pod relative to the chassis, when the pod or the chassis is hit by, or itself hits, an external object, etc.

Alternatively, the ends of the chains 5 and 7, which are respectively attached to a corner A of the pod as mentioned above, are instead respectively attached to two ends of a lengthy element pressing horizontally on side 15 of the pod and physically separated from the pod. Consequently, when the first electro-mechanical device retracts chains 5, 7, the lengthy element will be forced by the retracted chains 5, 7 to push the pod to move in direction 13. The chains 6 and 8 are similar attached to another element, to move the pod in direction 14.

U.S. Pat. No. 10,106,212 is incorporated herein by reference, it provides illustrative, non-limiting examples of moving a pod by retracting cables.

And, other conventional driving mechanism may be used to move the pod. For instance, the pod (without the chassis) is itself a vehicle with small size motor-driven wheels of a few cm in diameter, capable of moving on any planar or substantially planar surface, including the chassis floor or support plane 17, under the control of the control system.

Note that these driving mechanisms may also be applied/adapted to move the pod in the longitudinal directions (forward and backward direction).

Note also that the third embodiment may be combined with any of the above and below embodiments/examples/modifications/alternatives or a combination thereof.

Further, cushions 3 may be included in the third embodiment and be inflated, instantaneously, gradually or progressively, by a specific signal from the control system, when the pod is caused to move out of the chassis.

In one particular implementation, servo motors with capability of providing rotor movement information are used for retracting the chains and moving the pod, and basing on the rotor movement information, the control system can determine or continuously determine, before the pod is dropped from the chassis floor and hits ground, which part of the pod has been moved out of the chassis, and accordingly, causing those cushions 3—disposed on the pod, which are for protecting the surface(s) of the bottom of the moved-out part, and which may not be inflated at all, or partially/partly inflated before being moved out, to be all inflated to their full extent, or full operational extent, at a time before the pod is being moved completely out of the chassis and even hits ground.

Note that one of the above-mentioned purpose of inflation of cushions 3, for reducing frictions between the pod and the chassis floor (or support plane 17, if it exists) may not be necessary, as the chassis floor (or support plane 17) may be smooth itself and other conventional slide-assisting techniques may be employed.

As an alternative, a conventional free fall detection device (U.S. Pat. No. 9,076,471 is incorporated herein by reference, it provides illustrative, non-limiting examples) may be used to detect the free fall of the pod from the chassis, and issue a free fall signal to the control system, which in response thereto, causes cushions 3 disposed on the moved out part of the pod (and disposed on even part not moved out yet) and for use to protect the moved out part (and also, the not moved-out part), to be inflated to their full extent, or full operational extent, in the above-mentioned manner.

Other traditional methods, such as laser distance sensors, may be alternatively used for determining the position of the pod relative to the chassis. Notes that such a sensor can provide information of the pod movement and position, even if it is caused by an external impact, and cushions 3 may also be caused to be inflated in the above-mentioned manner, by using position of the pod relative to the chassis so obtained to determine the moved-out part.

And, U.S. Pat. No. 7,591,481 is also incorporated herein by reference, it provides illustrative, non-limiting examples of flow control mechanisms of pressurized fluid, which are usable in the present invention for selectively and gradually inflating the cushions 3.

According to a fourth embodiment, before using the above-mentioned driving mechanisms, to cause the pod to make any manner of movement (which may involve, raising up and/or tilting the pod with support plane 17, and/or moving the pod horizontally, and/or starting the movement sooner or later), the control system determines a preferred manner of movement for the pod, which would lead to a lesser loss, (including loss of lives, and/or loss of properties, and/or injuries, etc.), when compared with what loss would be resulted if making no movement. The loss may be owing to the detected/anticipated impact directly or indirectly on the pod, or any possible impact by the moved pod on a pedestrian, or by another vehicle on the moved pod, etc., when the pod is moved partly or completely on a vehicle lane or pedestrian path, which may be adjacent to the lane used by the vehicle to which the pod pertains, or in the vicinity thereof.

Desirably, the control system should find the preferred manner of movement, out of more than one possible manners (for e.g., moving the pod partly or completely out of the chassis) through comparisons of their respective anticipated losses, and the more possible manners, the more comparisons, the better. And, the preferred manner of movement may be no movement.

As an improvement, the preferred manner of movement may require the vehicle to move, by for e.g., autonomous driving. Specifically, the preferred manner of movement may require the vehicle to decelerate to a lower speed, and/or move into a new position, before the pod may be detached from the chassis and may also require the vehicle has to be at that speed and/or in that position, or at an even lower speed and/or in another new position, before the pod may be caused to move partly or completely out of the chassis, in the manner as mentioned above, in order to avoid the pod from impacting or being impacted by an external object, which would happen if the pod is detached or makes such a movement before the vehicle has moved to the new positions.

The control system is capable of detecting and identifying objects external to the present vehicle, such as, human beings, animals, vehicles, on the adjacent path, lane, nearby areas, or the like, and may include techniques used in conventional lane change assist and/or autonomous driving, for achieving this capability.

Desirably, the control system (and the driving mechanism) is capable of moving the pod to different extents, from partly to completely out of said vehicle.

Note that the control system will most likely cause the pod to move in direction 13 or 14, to evade from a detected/anticipated side impact, however, the control system may cause the pod to move forward or backward instead, and similarly, when a frontal or rear impact is detected/anticipated, the control system will most likely cause a longitudinal movement, but it may cause the pod to move in direction 13 or 14 movement instead, if it determines such a less expected movement will lead to a lesser loss.

The fourth embodiment can be applied to, or as a modification of, any of the above and below embodiments/examples/modifications/alternatives or a combination thereof.

As an alternative, the above-mentioned automatic movements of the pod caused by the control system, is also controllable, that is, can be stopped and/or if happened, the pod can be moved back to original position, by human commands received by the control system.

As a modification of any of the above and below embodiments/examples/modifications/alternatives or a combination thereof, after the pod has been moved by an external impact and/or the above-mentioned driving mechanism(s), and leaving a space in the chassis originally occupied by the pod itself at the time when it is in the above-mentioned normal use position, become partly or completely empty, the control system determines the dimensions of the space so left, or the space currently occupied by the pod, by using the above-mentioned technique for determination of pod position relative to the chassis, or by using the above-mentioned pressure sensor to detect if the pod is moved completely out of support plane 17, then causes conventional impact resisting/absorbing devices and/or intrusion prevention devices (may also include cushions 4 and/or support plane 17 and/or telescopic driving devices 18) to be extended/moved in a position such that they can occupy partly or completely of the space left, or even be extended/moved outside the vehicle, but not be extended/moved into the space currently occupied by the pod.

The present control system may activate two longitudinally extending bumper segments as disclosed by U.S. Pat. No. 6,926,322, to extend out of both sides of the present chassis respectively, and the bumper segment on the side which the pod is to be moved out, will be extended after the pod is detected as being moved out of the chassis, so as not to hinder the pod movement.

As an alternative, telescopic driving devices which may not be telescopic driving devices 18, may be under internal pressure by pressurized fluid (or by spring action), and therefore whenever the pod is moved away and leaves a space, those telescopic driving devices disposed surrounding the space will automatically be extended into the space by the pressurized fluid. In this alternative, the control system does not detect pod position, instead when it detects or anticipates a collision, it issues a signal to cause a fluid pressurizing device to supply pressurized fluid to the telescopic driving devices.

As a further simplification, the fluid pressurizing device is replaced by a container storing pre-pressurized fluid.

U.S. Pat. No. 6,601,719 is incorporated herein by reference, it provides illustrative, non-limiting examples of a telescoping boom assembly.

As another alternative, support plane 17 is replaced by a planar or substantial planar surface truss (alternatively, frame structure) and regardless of the pod may or may not be able to slide on it, the truss if being raised up, would still prevent intrusion by an external object into the chassis.

As a modification of any of the above embodiments/examples/modifications/alternatives or a combination thereof, the vehicle has a battery system in the chassis for providing electricity to, for e.g., a motor system for driving the vehicle. The above-mentioned control system is also for determining the battery system or other part of the chassis, is or will be on fire (which may or may not be caused by a detected/anticipated collision), by skills well-known to those in the art, and for issuing a fire hazard signal, to cause the above-mentioned attachment and detachment device to detach the pod from the chassis, and further, to cause the pod to be moved more separated from the chassis, for instance, causing cushions 3 and/or 4 to be inflated, and/or support plane 17 to be raised up.

And as a further modification, the control system causes the pod (with or without inflating cushions 3, and/or 4, and/or raising up support plane 17) to be moved in a preferred manner of movement if it determines in the above-mentioned manner that this will lead to a lesser loss.

In the above, various hazard escaping techniques are disclosed, they may be used in any vehicles with any traditional hazard detection systems for detecting different type of hazards, for e.g., collision or explosion of an oil tank of a diesel engine vehicle, as long as the vehicle has a pod.

As a modification of any of the above embodiments/examples/modifications/alternatives or a combination thereof, referring to FIG. 5, the exemplified vehicle as shown has a planar or substantially planar surface chassis (for instance, the commonly known skateboard chassis, in which a battery system, an electric motor and related mechanical parts of a vehicle are hidden inside), and similarly, the bottom of the pod has a planar or substantially planar surface, except that there are wheel recesses 22 in the pod, for corresponding respectively avoiding the wheels 23 of the chassis.

As to the support plane 24, it similarly has recess(es) or hole(s) for allowing any upward protruding part(s) of the chassis to go there through, so that it can be lowered down, as low as possible, to the upper surface of the chassis. Referring to FIG. 6, support plane 24 has four wheel recesses 25.

In pod transfer, the pod has the above-mentioned motor-driven wheels (not shown in the figures), for moving the pod horizontally out of support plane 24 (which is being raised up in the same manner as that of support plane 17, to a level above the wheels 23 as well as any upward extending part above the chassis which would impede the horizontal movement.), to an adjacent platform of the same or substantial same height as support plane 24.

The adjacent platform(s) may be a raised-up support plane 24 of another vehicle. If so, the control system of that another vehicle will cause its support plane 24 to lower the transferred pod to chassis floor level, so as to allow the pod be detachably secured to the chassis by an attachment device.

As misalignment of the pod transferor platform and the support plane 24 of the adjacent receiver, in a direction traverse to movement of the pod is inevitable, referring to FIG. 6, an exemplified lateral extending channel 26 (in real practice, more than one channel should be provided and the channels may alternatively be longitudinal) is provided on the surface of support plane 24. Note that the width of the channel is much wider at the margin than in the inner portion of support plane 24, to facilitate a pod wheel to move into it, when the pod moves from another platform to support plane 24.

Even if other driving mechanism is used to move to pod, channels 26 are still applicable to provide tolerance of misalignment of platforms, by using it to receive freely rotatable wheels of the pod, instead of the motor-driven wheels.

Before the pod transfer can be finished, the authority of controlling the pod has to be transferred from the control system of pod transferor, to the control system of the receiver, and this may be as simply as, for e.g., sending an address for sending commands to the pod wirelessly to the receiver. And, the pod is under control of the control system of the transferor or receiver, or both control systems in a cooperative manner, during the transfer.

As an improvement, there are barrier plates hinged to the four sides of support plane 24, under control of the control system, and can be moved from a horizontal or vertical down position, that is, non-barrier position, for allowing horizontal pod movement, to a vertical up position, that is, barrier position, for preventing horizontal pod movement, by using a conventional power operated car tailgate techniques,—and U.S. Pat. No. 6,357,813 is incorporated herein by reference, as illustrative, non-limiting examples.

In pod transfer, when the pod moves from another platform, into a support plane 24 from one side thereof, the control system (responsible for operating the support plane 24) causes one or more than one barrier plates at the other side of support plane 24, to be erected vertically, to stop the pod from further movement.

In hazard escaping, the control system selectively erects the barrier plate(s) vertically, to prevent the pod from moving to unpreferred direction(s), by an external impact or the like. The control system may further cause cushion(s) for protecting the side(s) of the pod facing the erected barrier plate(s), to be inflated, to prevent the pod from crashing with the barrier plate(s). The cushion(s) may be disposed in the pod or barrier plate(s).

Alternatively, the barrier plates may be in their barrier positions when no accident, and be selectively moved by the control system to a non-barrier position to allow the pod to move partly or completely out of the vehicle in preferred direction(s), in pod transfer or hazard escaping.

The innovative approach for determining the preferred manner of movement, is also used for determining the preferred and/or unpreferred direction(s), that is, the movement direction(s) which will lead to a lesser or greater loss, respectively. Alternatively, the preferred or unpreferred direction(s) may simply be the direction(s) which would lead the pod to move further away from, or face the detected/anticipated impact directly or more directly, respectively.

Note also that the barrier plates can be replaced with other conventional controllable barriers. And with such barriers, the above-mentioned driving mechanism for moving the pod horizontally in hazard escaping becomes not very necessary, can be eliminated to save costs, but it is still desirable.

The mechanical guiding techniques as disclosed above for pod transfer, that is, channels 26 and barrier plates, may be replaced or used in combination with other conventional techniques, for instance, U.S. Pat. No. 7,801,645 discloses an edge detection system used in a robotic vacuum cleaner, which can be used by the pod to locate edges of support plane 24.

In a first modification, the chassis has no upward protruding part, for e.g., the exemplified vehicle has a planar or substantially planar surface chassis, similar to the one as shown in FIG. 5, but has small road-running wheels, so small that they are completely below the chassis, and there is no need for support plane 17 or 24 to raise up the pod, to enable horizontal movement of the pod.

In a second modification, the chassis with the small road-running wheels, has one and only one upward protruding part, which is the chassis head, and the pod when detached from the chassis, can be moved backward, or sideway, and support plane 17 or 24 could also be saved.

In both modifications, longitudinal or lateral channels 26 may be formed on the surface of the chassis to facilitate pod transfer, and barrier plates may also be disposed at the sides of the chassis, to prevent the pod to move in an unpreferred direction, in the above-mentioned manner.

Note that in the above embodiments, the control system may be any conventional computing system comprising one or more than one processing units installed in the chassis or the pod, or partly in the chassis and partly in the pod, or partly or completely cloud based.

It should be readily appreciated that the disclosure herein related to, or functions of support plane 17 (for hazard escaping), may be applied to, or performed by, support plane 24 (for pod transfer), and vice versa.

It should be noted that the above embodiments/examples/modifications/alternatives are given by way of examples only, and it will be obvious to those skilled in the art that various changes and modifications may be made without departing from the spirit of the present invention.

What is claimed is:

1. An apparatus for use in a land vehicle, said vehicle has a carrier which is for carrying at least one person, and said carrier is being laid on a support part of said vehicle, and is detachably secured to said vehicle, comprising:
means for detecting a hazard event or an imminent hazard event involving said vehicle, and for providing hazard event information related to a hazard event or an imminent hazard event so detected;
detaching means for causing said carrier to be detached from said vehicle, if said hazard event information is received;
moving means for causing said carrier to be moved on said support part, in one or more than one directions;
means for detecting and identifying objects external to said vehicle;
means for assessing loss may be resulted, if said carrier is to be moved, or not to be moved, by said moving means, basing on said hazard event information, and result of said detection and/or result of said identification if said identification is successful;
means for determining a manner for moving said carrier, if said assessed loss related to said manner is lower than said assessed loss related to no movement, and if otherwise, said manner as determined will be no movement;
wherein said moving means moves said carrier in according to said manner determined;
wherein said carrier includes no road-running wheel of said vehicle.

2. An apparatus as claimed in claim 1, wherein said moving means comprises a means for raising up said support part to a height above at least one upward protruding part of said vehicle, so as to enable said carrier which being laid on said support part, to be moved horizontally and not be hindered by said at least one upward protruding part; or for raising up said support part to such a height that said carrier can be moved over said at least one upward protruding part.

3. An apparatus as claimed in claim 1, wherein said determined manner is being selected out of a number of different manners of movement, and said assessed loss related to said determined manner is the lowest among said assessed losses related to said different manners of movement.

4. An apparatus as claimed in claim 1, wherein said determined manner may require said moving means to move said carrier partly or completely out of said vehicle and said moving means is capable of moving said carrier as may be so required;
wherein further comprising a means for receiving a user command, and in response thereto, stopping said moving means from moving said carrier, and/or if said carrier has been moved, causing said moving means to move said carrier back.

5. An apparatus as claimed in claim 1, wherein said determined manner requires said vehicle to decelerate to a first speed, and/or move to a first position, before said detaching means can cause said carrier to be detached from said vehicle, and/or said moving means can cause said carrier to be moved.

6. An apparatus as claimed in claim 5, wherein said determined manner further requires said vehicle to decelerate to a second speed which is slower than said first speed, and/or move from said first position to a second position, before said moving means can cause said carrier to be moved.

7. An apparatus for use in a land vehicle, said vehicle has a carrier which is for carrying at least one person, and said carrier is being laid on a support part of said vehicle, and is detachably secured to said vehicle, comprising:
means for detecting a hazard event or an imminent hazard event involving said vehicle, and for providing hazard event information related to a hazard event or an imminent hazard event so detected;
means for causing said carrier to be detached from said vehicle, if said hazard event information is received;
means for detecting and identifying objects external to said vehicle;
means for assessing loss would be resulted, if said carrier is to be moved in different directions, or not to be moved, basing on said hazard event information, and result of said detection and/or result of said identification if said identification is successful;
means for determining preferred and/or unpreferred direction(s) of movement, basing on said assessed losses;
barrier means for preventing said carrier from being moved in said unpreferred direction(s), and/or for enabling said carrier to be moved in said preferred direction(s);
wherein said assessed loss(es) related to said preferred direction(s) is/are lower than said assessed loss(es) related to said unpreferred direction(s);
wherein said carrier includes no road-running wheel of said vehicle.

8. An apparatus as claimed in claims 1 or 7, wherein said loss includes loss of lives, and/or loss of properties, and/or injuries.

9. An apparatus as claimed in claims 1 or 7, wherein said hazard event is a fire and/or a collision, and if said hazard event is a collision, said hazard event information includes information related to a collision impact from which said vehicle is or will be suffered.

10. An apparatus as claimed in claims 1 or 7, wherein said vehicle is a chassis with or without autonomous driving capability;
wherein motor-driven wheels disposed on said carrier, and/or means for retracting cables connecting said carrier with said vehicle, are used for causing said movement of said carrier.

11. An apparatus as claimed in claim 7, wherein further comprising a means for raising up said support part to a height above at least one upward protruding part of said vehicle, so as to enable said carrier to be moved horizontally and unhindered by, said at least one upward protruding part; or for raising up said support part to such a height that said carrier laid on said support part, can be moved over said at least one upward protruding part.

12. An apparatus as claimed in claim 7 or 11, wherein said barrier means comprising one or a plurality of plates disposed at one or more than one edges of said support part, for blocking movement of said carrier in one or more than one directions, and whether a said plate is erected up or not, is dependent on said preferred and/or unpreferred direction(s), and the direction said a said plate being for blocking.

13. An apparatus as claimed in claim 12, wherein further comprising means for causing at least one cushion device disposed on said carrier or said plates, to be activated, for protecting a surface of said carrier, facing at least a said blocking plate erected.

14. An apparatus as claimed in claim 1 or 7, wherein further comprising:
activating means for causing at least one cushion device disposed on said carrier, for protecting a part of said carrier which is being moved out of said vehicle, to be activated to full extent or full operational extent;
wherein said at least one cushion device will occupy a space below said moved-out part when activated;
wherein said at least one cushion device is not activated at all, or is partially or partly activated, before said part of said carrier being moved out of said vehicle.

15. An apparatus as claimed in claim 14, wherein said activating means comprising means for determining said part of said carrier as being moved out of said vehicle.

16. An apparatus as claimed in claim 15, wherein said activating means further comprising means for detecting free fall of said carrier, and said activating means activates said at least one cushion device, if said free fall is detected.

17. An apparatus as claimed in claim 1 or 7, wherein said vehicle comprising:
protection means for causing an impact resisting/absorbing device, and/or a device for preventing entry of an external object into said vehicle, to occupy a space provided by movement of said carrier, partly or entirely.

18. An apparatus as claimed in claim 1 or 7, wherein said vehicle further comprising:
protection means for causing an impact resisting/absorbing device, and/or a device for preventing entry of an external object into said vehicle, to occupy a space inside and/or outside said vehicle;
means for preventing said devices from being attempted to be moved or extended into the space occupied by said carrier.

19. An apparatus as claimed in claims 17 or 18, wherein said protection means comprising first means for detecting if said carrier is completely being moved out of said vehicle, and/or second means for determining position of said carrier relative to said vehicle;
wherein basing on result obtained from said first means and/or said second means, said protection means determines dimensions of the space provided by movement of said carrier and/or the space occupied by said carrier.

20. An apparatus as claimed in claim 17 or 18, wherein said protection means comprising means for raising up and/or tilting said support part of said vehicle, and said impact resisting/absorbing device, and/or said device for preventing entry of an external object, includes said support part.

21. An apparatus as claimed in claim 17, wherein said impact resisting/absorbing device, and/or said device for preventing entry of an external object into said vehicle, being operated under an internal pressure for automatically moving into said space, and to occupy at least a part of said space.

22. An apparatus as claimed in claim 21, wherein said protection means also being for causing/enabling a pressurizing means for providing said internal pressure, if said hazard event information is received.

23. An apparatus as claimed in claims 7, 14, 17 or 18, wherein said movement of said carrier is caused by a means for moving said carrier and/or a collision impact, directly or indirectly.

24. A land vehicle comprising the apparatus as claimed in any one of the claims 1 to 23.
